(19) United States
(12) Patent Application Publication
(10) Pub. No.: US 2016/0161665 A1
(43) Pub. Date: Jun. 9, 2016

(54) DISPLAY DEVICE AND BACKLIGHT MODULE

(71) Applicant: Young Lighting Technology Inc., Hsin-Chu (TW)

(72) Inventors: Ching-Hung Chen, Hsin-Chu (TW); Wen-Pin Yang, Hsin-Chu (TW); Chi-Sheng Liao, Hsin-Chu (TW); Chun-Chung Hsiao, Hsin-Chu (TW); Ruei-An Lyu, Hsin-Chu (TW); Hua-Te Feng, Hsin-Chu (TW)

(21) Appl. No.: 14/793,755

(22) Filed: Jul. 8, 2015

(30) Foreign Application Priority Data
Dec. 9, 2014 (TW) 103142813

(51) Int. Cl. F21V 8/00

(52) U.S. Cl. CPC G02B 6/0085

(57) ABSTRACT

A display device including a heat dissipation component, a display panel, a light guide plate, an optical film set, and a light source set is provided. The heat dissipation component has a supporting surface, a first connecting surface, and a second connecting surface. The supporting surface supports the display panel. The light guide plate is connected to the first connecting surface, and has a light incident surface and a light emitting surface. The optical film set is connected to the second connecting surface, and located between the light guide plate and the display panel, wherein the light emitting surface of the light guide plate faces the optical film set. The light source set is disposed on the heat dissipation component, and aligned to the light incident surface of the light guide plate. A backlight module adapted to the display device is also provided.

### CROSS-REFERENCE TO RELATED APPLICATION

This application claims the priority benefit of Taiwan application serial no. 103142813, filed on Dec. 9, 2014. The entirety of the above-mentioned patent application is hereby incorporated by reference herein and made a part of this specification.

### BACKGROUND OF THE INVENTION

1. Field of the Invention

The invention relates to a display device and more particularly to a display device having a display panel and a backlight module.

2. Description of Related Art

With advancement in semiconductor industry and relevant electronic industries, digital display devices such as smart phones, notebooks, tablet PCs, and flat panel TVs have made progress to meet requirements for easy operation, multiple functionalities, and attractive exterior design. Display screens are indispensable when using these products, and liquid crystal displays (LCDs) have become a main stream of the display screens. Since LCD panels of the LCDs are not equipped with a self-illuminating function, a backlight module must be disposed underneath the LCD panels to provide a light source for displaying images.

Generally, a material for a light guide plate of the backlight module is plastic material such as polymethyl methacrylate (PMMA). Since structural strength of the light guide plate made of PMMA is relatively low and is prone to be warped and deformed when heated, a minimum thickness of the light guide plate is restricted and cannot facilitate miniaturization of the display device. Meanwhile, a plastic frame is required to be provided on a back plate of a backlight module of a conventional display device so as to assemble components such as an optical film set and a display panel. However, an overall thickness of the display device cannot be reduced due to excessive components, and thin display devices cannot be realized. In addition, the excessive components bring about difficulty in assembling the display device increase production costs. Therefore, a solution of how to miniaturize the display device in thickness is highly desired.

Taiwan Patent No. TWM482084 discloses a mold-frame-absent frame type back plate structure, in which a light guide plate is fixed by adopting a depressed side plate of a back plate. Taiwan Patent Application Publication No. TW201405211 discloses a display device, wherein a light guide plate is made of glass and is adhered to a back plate by a double-side tape. Taiwan Patent Application Publication No. TW201304961 discloses an adhered structure, wherein a first double-sided adhesive tape and a second double-sided adhesive tape are adhered to a first object and a second object, respectively, and a separating membrane is adhered between the first double-sided adhesive tape and the second double-sided adhesive tape.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention provides a display device which facilitates designs for miniaturization in thickness and easy assembling, and also reducing production costs.

The invention provides a backlight module which facilitates designs for miniaturization in thickness.

Other objects and advantages of the invention may be further illustrated by the technical features broadly embodied and described as follows.

To achieve one or a portion of or all of the objects or other objects, an embodiment of the invention provides a display device, which includes a heat dissipation component, a display panel, a light guide plate, an optical film set and a light source set. The heat dissipation component has a supporting surface, a first connecting surface, and a second connecting surface. The supporting surface supports the display panel. The light guide plate is connected to the first connecting surface, and has a light incident surface and a light emitting surface. The optical film set is connected to the second connecting surface, and is located between the light guide plate and the display panel. The light emitting surface of the light guide plate faces the optical film set.

The light source set is disposed on the heat dissipation component, and is aligned to the light incident surface of the light guide plate.

In an embodiment, the display panel has a display surface, a back surface opposite to the display surface, and a side surface which connects the display surface and the back surface. The supporting surface supports the back surface. The heat dissipation component has a stopping portion. The stopping portion stops the side surface.

In an embodiment, the display device includes a first gluing material, wherein the light guide plate is adhered to the first connecting surface by the first gluing material.

In an embodiment, the first gluing material is adhered to a portion of the light emitting surface of the light guide plate.

In an embodiment, the first gluing material includes a first separating layer and two first adhesive layers. The two first adhesive layers are adhered to two opposite sides of the first separating layer, respectively.

In an embodiment, the optical film set has a positioning opening. A positioning pillar is provided on the second connecting surface, and the positioning pillar extends into the positioning opening.

In an embodiment, the display device has a front side and a back side opposite to each other, and includes a front cover and a plurality of second gluing materials, wherein the display device displays an image through the front side, the front cover is disposed at the front side and is adhered to the heat dissipation component and the display panel by the second gluing materials, respectively.

In an embodiment, each of the second gluing materials includes a second separating layer and two second adhesive layers. The two second adhesive layers are adhered to two opposite sides of the second separating layer, respectively.

In an embodiment, the display device has a front side and a back side opposite to each other, and includes a back cover and a third gluing material, wherein the display device displays an image through the front side, the back cover is disposed at the back side and is adhered to the heat dissipation component by the third gluing material.

In an embodiment, the third gluing material includes a third separating layer and two third adhesive layers. The two third adhesive layers are adhered to two opposite sides of the third separating layer, respectively.

In an embodiment, the heat dissipation component has a flange. The flange has a first side and a second side opposite to each other. The supporting surface and the second connecting surface are formed at the first side. The first connecting surface is formed at the second side.

In an embodiment, the heat dissipation component has a first surface and a second surface. The first surface faces the light incident surface of the light guide plate. The light source set includes a substrate, at least one light emitting element, and a connector. The substrate is disposed at the heat dissipation component and has a first portion and a second portion which bends relative to the first portion. The first portion and the second portion are located on the first surface and the second surface, respectively. The light emitting element and the connector are disposed at the first portion and the second portion, respectively.

In an embodiment, the heat dissipation component includes a plurality of parts. The parts are connected to form a frame. The frame surrounds the display panel, the light guide plate, and the optical film set.

In an embodiment, the heat dissipation component is an integrated frame. The frame surrounds the display panel, the light guide plate, and the optical film set.

In an embodiment, the light guide plate is a glass light guide plate.

In order to achieve one or a portion of or all of the objects or other objects, an embodiment of the invention provides a backlight module, which includes a heat dissipation component, a light guide plate, an optical film set and a light source set. The heat dissipation component has a first connecting surface and a second connecting surface. The light guide plate is connected to the first connecting surface, and has a light incident surface and a light emitting surface. The optical film set is connected to the second connecting surface, wherein the light emitting surface of the light guide plate faces the optical film set. The light source set is disposed on the heat dissipation component, and is aligned to the light incident surface of the light guide plate.

The embodiments of the invention at least have one of the following advantages. The display device adopts the heat dissipation component to support the display panel and connect the light guide plate and the optical film set, instead of assembling the display panel, the light guide plate and the optical film set by arranging an additional plastic frame in a conventional display device. In this way, assembly difficulty and fabrication costs may be reduced by reducing quantities of components of a display device, and miniaturization of a display device in thickness is further facilitated. In addition, embodiments of the display device of the invention adopt a light guide plate which has stronger structural strength and would not be easily warped and deformed when heated. Thus, the light guide plate may have thinner thickness and facilitates miniaturization of the display device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating a display device according to an embodiment of the invention.

FIG. 2 is a schematic partial enlarged view illustrating the display device depicted in FIG. 1 at a first gluing material.

FIG. 3 is a schematic partial enlarged view illustrating the display device depicted in FIG. 1 at second gluing materials.

FIG. 4 is a schematic partial enlarged view illustrating the display device depicted in FIG. 1 at a third gluing material.

FIG. 5 is a schematic top view illustrating the heat dissipation component depicted in FIG. 1.

FIG. 6 is a schematic cross-sectional view illustrating a display device according to another embodiment of the invention.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

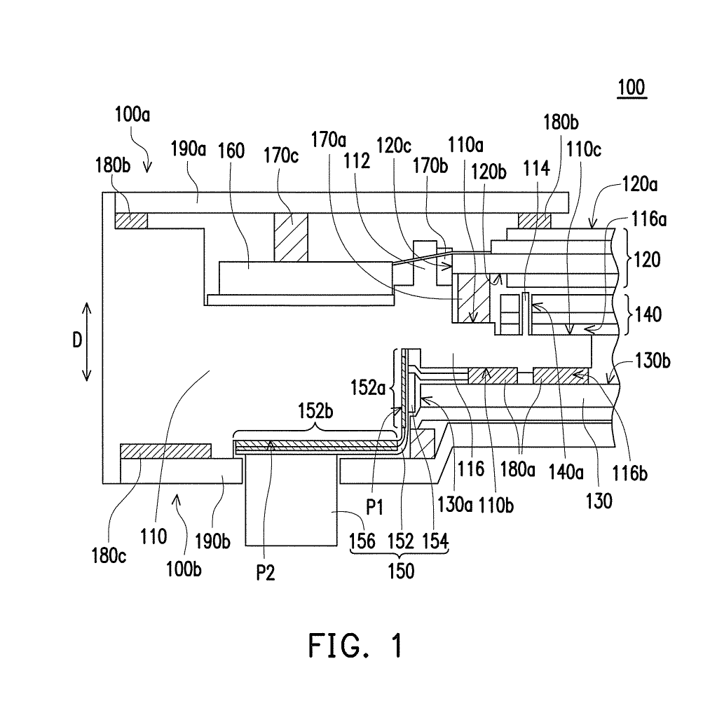

FIG. 1 is a schematic cross-sectional view illustrating a display device according to an embodiment of the invention. With reference to FIG. 1, a display device 100 of the present embodiment includes a heat dissipation component 110, a display panel 120, a light guide plate 130, an optical film set 140 (three films are illustrated herein as an example), and a light source set 150. The display device 100 is a display device such as a flat panel TV or other types, and may exemplarily include the liquid crystal display, but the invention is not limited herein. A backlight module includes the heat dissipation component 110, the light guide plate 130, the optical film set 140, and the light source set 150 to provide lights required for the display panel 120 to display images.

The heat dissipation component 110, for example, is a frame, and has a supporting surface 110a, a first connecting surface 110b, and a second connecting surface 110c. The supporting surface 110a of the heat dissipation component 110 supports the display panel 120. The light guide plate 130 is connected to the first connecting surface 110b of the heat dissipation component 110, and has a light incident surface 130a and a light emitting surface 130b which are perpendicular to each other. The optical film set 140 includes at least one optical film and is connected to the second connecting surface 110c of the heat dissipation component 110, and located between the light guide plate 130 and the display panel 120. The second connecting surface 110c of the heat dissipation component 110 supports the optical film set 140, and the light emitting surface 130b of the light guide plate 130 faces the optical film set 140. The light source set 150 is disposed on the heat dissipation component 110 to dissipate heat through the heat dissipation component 110. The light source set 150 is aligned to the light incident surface 130a of the light guide plate 130, such that lights emitted from the light source set 150 enter the light guide plate 130 from the light incident surface 130a and irradiate toward the display panel 120 from the light emitting surface 130b by guidance of the light guide plate 130.

The display device 100 adopts the heat dissipation component 110 to support the display panel 120 and connects the light guide plate 130 and the optical film set 140, and there is no need to assemble a display panel, a light guide plate and an optical film set by using an additional plastic frame in a conventional display device. Therefore, quantities of components required for the display device 100 are reduced so that assembly difficulty thereof and fabrication costs can also be reduced, which facilitate miniaturization of the display device 100 in thickness. In one embodiment, the light guide plate 130 which is configured in the display device 100 is, for example, a glass light guide plate, such that the light guide plate 130 has stronger structural strength, and less warped and deformed when heated. Thus, the light guide plate 130 may have thinner thickness and facilitates miniaturization of the display device 100 in thickness. However, the invention does not limit materials of the light guide plate 130. Materials having stronger structural strength and less warpage and deformation when heated may be used as a light guide plate.

As illustrated in FIG. 1, in one embodiment, the heat dissipation component 110 further has a flange 116. The flange 116 has a first side 116a and a second side 116b which are opposite to each other. The supporting surface 110a and the second connecting surface 110c are formed at the first side 116a of the flange 116, and the first connecting surface 110b is formed at the second side 116b of the flange 116. In other embodiments, the supporting surface 110a, the first connecting surface 110b, and the second connecting surface 110c may be arranged at other suitable locations of the heat dissipation component 110, respectively, which should not be construed as a limitation to the invention.

The display panel 120 of the present embodiment has a display surface 120a, a back surface 120b opposite to the display surface 120a, and a side surface 120c which connects the display surface 120a and the back surface 120b. The supporting surface 110a of the heat dissipation component 110 supports the back surface 120b of the display panel 120. The heat dissipation component 110 has a stopping portion 112. The stopping portion 112 stops the side surface 120c of the display panel 120 to locate the display panel 120. In the present embodiment, the display device 100 includes a driving element 160 which is configured for driving the display panel 120. The driving element 160 is disposed on the heat dissipation component 110 and electrically connected to the display panel 120. In addition, the display device 100 includes a buffer 170a and a buffer 170b. The buffer 170a is disposed between the back surface 120b of the display panel 120 and the supporting surface 110a of the heat dissipation component 110, and the buffer 170b is disposed between the side surface 120c of the display panel 120 and the stopping portion 112 of the heat dissipation component 110, wherein the buffer 170a and the buffer 170b are, for example, elastic materials such as rubber, silica gel, and the like, which provides a buffering force between the display panel 120 and the heat dissipation component 110, so as to prevent the display panel 120 from being damaged. However, the buffer 170a and the buffer 170b may be other suitable materials, which should not be construed as a limitation to the invention.

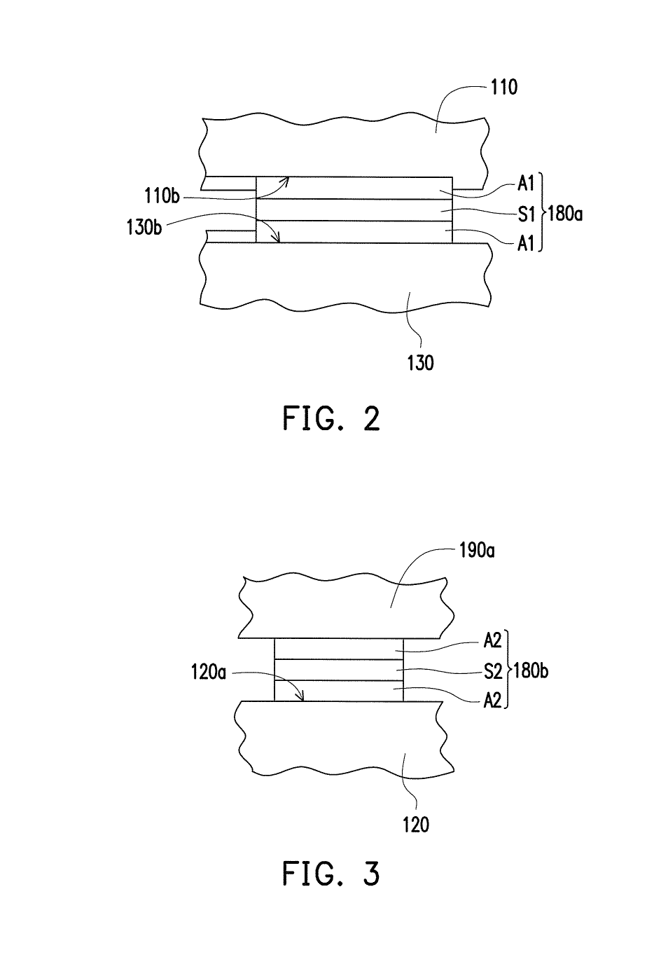

In one embodiment, the display device 100 includes at least one first gluing material 180a (several are exemplarily illustrated in FIG. 1). The light guide plate 130 is adhered to the first connecting surface 110b of the heat dissipation component 110 by the first gluing material 180a, wherein the first gluing material 180a is, for example, adhered to a portion of the light emitting surface 130b of the light guide plate 130. FIG. 2 is a schematic partial enlarged view illustrating the display device depicted in FIG. 1 at a first gluing material. With reference to FIG. 2, in one embodiment, the first gluing material 180a includes a first separating layer S1 and two first adhesive layers A1. The two first adhesive layers A1 are adhered to two opposite sides of the first separating layer S1, respectively. The two first adhesive layers A1 are able to be separated from each other by the first separating layer S1, such that the guide light plate 130 and the heat dissipation component 110 are easy to be taken apart and reworked.

With reference to FIG. 1, in one embodiment, the optical film set 140 has a positioning opening 140a. The heat dissipation component 110 has a positioning pillar 114 on the second connecting surface 110c. Though one pillar is exemplarily indicated in FIG. 1, but the invention is not limited thereto and may includes more than one pillar in other embodiment. The positioning pillar 114 extends into the positioning opening 140a to locate the optical film set 140. In other embodiments, the heat dissipation component 110 may locate the optical film set 140 by other suitable structures, which should not be construed as a limitation to the invention. In addition, in other embodiments which are not illustrated, another buffer can be further provided between the second connecting surface 110c of the heat dissipation component 110 and the optical film set 140, wherein the buffer provides buffering forces between the second connecting surface 110c of the heat dissipation component 110 and the optical film set 140, and may further prevent heat of the heat dissipation component 110 from being directed to the optical film set 140, which may cause the optical film set 140 to warp, deform and melt due to thermal damages.

As illustrated in FIG. 1, in one embodiment, the display device 100 further includes a front cover 190a, a back cover 190b, two second gluing materials 180b, and a third gluing material 180c. In one embodiment, the driving element 160 is accommodated in a recess of the heat dissipation component 210 and the recess faces the front cover 190a. The display device 100 has a front side 100a and a back side 100b which are opposite to each other, and displays an image through the front side 100a. The front cover 190a is adhered to the heat dissipation component 110 and the display panel 120 by the two second gluing materials 180b, respectively, and disposed at the front side 100a. The back cover 190b is adhered to the heat dissipation component 110 by the third gluing material 180c, and disposed at the back side 100b.

In addition, the display device 100 may further include a fixed member 170c. The fixed member 170c is disposed between the front cover 190a and the driving element 160, wherein the fixed member 170c is configured for fixing the driving element 160, and the fixed member 170c is made of an elastic material such as rubber, silica gel, and the like, which provides a buffering force between the front cover 190a and the driving element 160, so as to prevent the driving element 160 from being damaged. However, the fixed member 170c may be other suitable materials, which should not be construed as a limitation to the invention.

FIG. 3 is a schematic partial enlarged view illustrating the display device depicted in FIG. 1 at second gluing materials. With reference to FIG. 3, each of the second gluing materials 180b includes a second separating layer S2 and two second adhesive layers A2. The two second adhesive layers A2 are adhered to two opposite sides of the second separating layer S2, respectively. The two second adhesive layers A2 are able to be separated from each other by the second separating layer S2, such that the front cover 190a and the display panel 120 are easy to be taken apart and reworked. The second gluing material 180b, as illustrated in FIG. 3, is configured for adhering the front cover 190a and the display panel 120, and the second gluing material 180b which is configured for adhering the front cover 190a and the heat dissipation component 110 is the same as that illustrated in FIG. 3, which is not reiterated hereinafter.

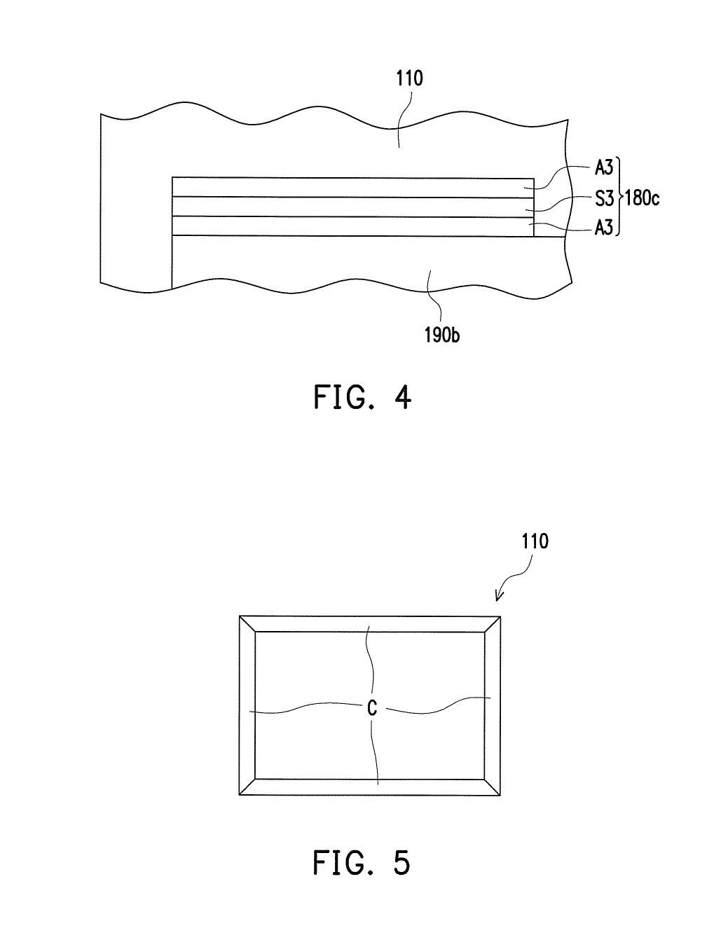

FIG. 4 is a schematic partial enlarged view illustrating the display device depicted in FIG. 1 at a third gluing material. With reference to FIG. 4, the third gluing material 180c includes a third separating layer S3 and two third adhesive layers A3. The two third adhesive layers A3 are adhered to two opposite sides of the third separating layer S3, respectively. The two third adhesive layers A3 are able to be separated from each other by the third separating layer S3, such that the back cover 190b and the heat dissipation component 110 are easy to be taken apart and reworked.

FIG. 5 is a schematic top view illustrating the heat dissipation component depicted in FIG. 1. With reference to FIG. 5, the heat dissipation component 110 is made of for example, aluminum, and includes a plurality of parts C (four is exemplarily illustrated in FIG. 5). The parts C are connected together by soldering to form a frame. As illustrated in FIG. 1, the frame surrounds the display panel 120, the light guide plate 130, and the optical film set 140. By designing the heat dissipation component 110 to be a frame and adopting the frame as a primary supporting structure for the display device 100, and selecting the light guide plate 130 which has stronger structural strength (e.g. glass light guide plate), structural strength of the front cover 190a and the back cover 190b in the display device 100 may be reduced, such that the front cover 190a and the back cover 190b may be lighter and thinner. In other embodiments, the heat dissipation component 110 may be formed to be a frame by fixing screws, tenons, bonding or other connecting means. Alternatively, the heat dissipation component 110 may be an integrated frame, but the invention is not limited thereto.

With reference to FIG. 1, in one embodiment, the heat dissipation component 110 has a first surface P I and a second surface P2. The first surface P1 faces the light incident surface 130a of the light guide plate 130. The second surface P2, for example, is perpendicular to the first surface P1 and faces the back cover 190b. The second surface P2 is adjacent to the first surface P1 and is connected to the first surface P1. The light source set 150 includes a substrate 152, at least one light emitting element 154, and a connector 156. The substrate 152 is disposed at the heat dissipation component 110, and has a first portion 152a and a second portion 152b which bend relative to each other. The first portion 152a and the second portion 152b are located on the first surface P1 and the second surface P2 of the heat dissipation component 110, respectively. The substrate 152 is, for example, a circuit board, and may be a flexible printed circuit board (FPCB), a metal core printed circuit board (MCPCB), or other circuit board which is suitable to be bended and located on the first surface P1 and the second surface P2 of the heat dissipation component 110, respectively. However, the invention is not limited thereto. The light emitting element 154, for example, is a light emitting diode (LED) element and disposed at the first portion 152a. In one embodiment, the number of light emitting element 154 is plural. The connector 156 is disposed at the second portion 152b. An extending length of the substrate 152 in a thickness direction D of the display device 100 may be shortened by designing the substrate 152 to be a bending structure as described above, and a thickness of the display device 100 may be reduced.

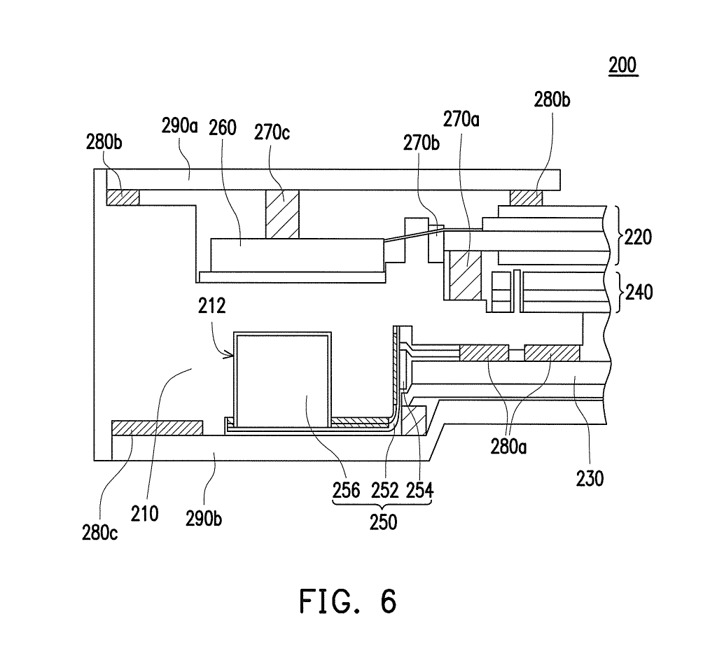

FIG. 6 is a schematic cross-sectional view illustrating a display device according to another embodiment of the invention. In a display device 200 depicted in FIG. 6, arrangements and functions s of a heat dissipation component 210, a display panel 220, a light guide plate 230, an optical film set 240, a light source set 250, a substrate 252, a light emitting element 254, a driving element 260, buffers 270a and 270b, a fixed member 270c, a first gluing material 280a, a second gluing materials 280b, a third gluing material 280c, a front cover 290a, and a back cover 290b are similar to the arrangements and functions of the heat dissipation component 110, the display panel 120, the light guide plate 130, the optical film set 140, the light source set 150, the substrate 152, the light emitting element 154, the driving element 160, the buffers 170a and 170b, the fixed member 170c, the first gluing material 180a, the second gluing materials 180b, the third gluing material 180c, the front cover 190a, and the back cover 190b which are depicted in FIG. 1, and are not reiterated again herein. A difference between the display device 200 and the display device 100 lies in that the connector 256 of the light source set 250 is disposed to face the heat dissipation component 210 and accommodated in a recess 212 of the heat dissipation component 210, rather than the connector 156 as shown in FIG. 1 which is disposed to face the back cover 190b and extends to an exterior of the back cover 190b. With such arrangement, a thickness of the display device 200 may be further reduced.

The embodiments of the invention at least have one of the following advantages. In the embodiments of the invention, the display device adopts the heat dissipation component to support the display panel and connect the light guide plate and the optical film set, instead of assembling a display panel, a light guide plate and an optical film set by arranging an additional plastic frame in a conventional display device. In this way, assembly difficulty and fabrication costs may be reduced because fewer components for a display device are required, and miniaturization of a display device in thickness is further facilitated. In addition, embodiments of the display device of the invention adopt a light guide plate which has stronger structural strength and would not be easily warped and deformed when heated. Therefore, the light guide plate may have a thinner thickness which facilitates miniaturization of the display device. In addition, by designing the heat dissipation component to be a frame and adopting the frame as a primary supporting structure for the display device, and selecting the light guide plate which has stronger structural strength, structural strength of the front cover and the back cover in the display device may be reduced, such that the front cover and the back cover may be designed to be lighter and thinner. Furthermore, when the substrate of the light source set is designed to be a bending structure, an extending length of the substrate in a thickness direction of the display device may be shortened, and a thickness of the display device may be thinner.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display device, comprising:
a heat dissipation component, having a supporting surface, a first connecting surface, and a second connecting surface;
a display panel, the supporting surface supporting the display panel;
a light guide plate, connected to the first connecting surface, and having a light incident surface and a light emitting surface;
an optical film set, connected to the second connecting surface, and located between the light guide plate and the display panel, wherein the light emitting surface of the light guide plate faces the optical film set; and
a light source set, disposed on the heat dissipation component, and aligned to the light incident surface of the light guide plate.

2. The display device as claimed in claim 1, wherein the display panel has a display surface, a back surface opposite to the display surface, and a side surface connecting the display surface and the back surface, the supporting surface supports the back surface, the heat dissipation component has a stopping portion, and the stopping portion stops the side surface.

3. The display device as claimed in claim 1, comprising a first gluing material, wherein the light guide plate is adhered to the first connecting surface by the first gluing material.

4. The display device as claimed in claim 3, wherein the first gluing material is adhered to a portion of the light emitting surface of the light guide plate.

5. The display device as claimed in claim 3, wherein the first gluing material comprising a first separating layer and two first adhesive layers, the two first adhesive layers are adhered to two opposite sides of the first separating layer, respectively.

6. The display device as claimed in claim 1, wherein the optical film set has a positioning opening, a positioning pillar is provided on the second connecting surface, and the positioning pillar extends into the positioning opening.

7. The display device as claimed in claim 1, further comprising a front side, a back side opposite to the front side, a front cover and a plurality of second gluing materials, wherein the display device displays an image through the front side, and the front cover is disposed at the front side and is adhered to the heat dissipation component and the display panel by the second gluing materials respectively.

8. The display device as claimed in claim 7, wherein each of the second gluing materials comprises a second separating layer and two second adhesive layers, the two second adhesive layers are adhered to two opposite sides of the second separating layer, respectively.

9. The display device as claimed in claim 1, further comprising a front side, a back side opposite to the front side, a back cover and a third gluing material, wherein the display device displays an image through the front side, and the back cover is disposed at the back side and is adhered to the heat dissipation component by the third gluing material.

10. The display device as claimed in claim 9, wherein the third gluing material comprises a third separating layer and two third adhesive layers, and the two third adhesive layers are adhered to two opposite sides of the third separating layer, respectively.

11. The display device as claimed in claim 1, wherein the heat dissipation component has a flange, the flange has a first side and a second side opposite to the first side, the supporting surface and the second connecting surface are formed at the first side, and the first connecting surface is formed at the second side.

12. The display device as claimed in claim 1, wherein the heat dissipation component has a first surface and a second surface, the first surface faces the light incident surface of the light guide plate, the light source set comprises a substrate, at least one light emitting element, and a connector, the substrate is disposed at the heat dissipation component and has a first portion and a second portion bending relative to each other, the first portion and the second portion are located on the first surface and the second surface, respectively, and the light emitting element and the connector are disposed at the first portion and the second portion, respectively.

13. The display device as claimed in claim 12, wherein the heat dissipation component has a flange, the flange has a first side and a second side opposite to the first side, the supporting surface and the second connecting surface are formed at the first side, and the first connecting surface is formed at the second side.

14. The display device as claimed in claim 1, wherein the heat dissipation component comprises a plurality of parts, the parts are connected to form a frame, and the frame surrounds the display panel, the light guide plate, and the optical film set.

15. The display device as claimed in claim 1, wherein the heat dissipation component is an integrated frame, the frame surrounds the display panel, the light guide plate, and the optical film set.

16. The display device as claimed in claim 1, wherein the light guide plate is a glass light guide plate.

17. A backlight module, comprising:
a heat dissipation component, having a first connecting surface and a second connecting surface;
a light guide plate, connected to the first connecting surface, and having a light incident surface and a light emitting surface;
an optical film set, connected to the second connecting surface, wherein the light emitting surface of the light guide plate faces the optical film set; and
a light source set, disposed on the heat dissipation component, and aligned to the light incident surface of the light guide plate.
